(19) United States
(12) Patent Application Publication
(10) Pub. No.: US 2009/0297051 A1
(43) Pub. Date: Dec. 3, 2009

(54) Image Processing Apparatus

(75) Inventors: Tomoyuki Nonaka, Chigasaki (JP); Hironori Komi, Tokyo (JP); Keisuke Inata, Ebina (JP); Yusuke Yatabe, Yokohama (JP); Mitsuhiro Okada, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/429,446

(22) Filed: Apr. 24, 2009

(30) Foreign Application Priority Data
May 28, 2008 (JP) 2008-138855

(51) Int. Cl. G06K 9/36

(52) U.S. Cl. 382/232

(57) ABSTRACT

An image processing apparatus is configured to have units for compressing and expanding image data and an arbitrating unit for arbitrating control units for executing image processing so that the compressing and expanding units are located between the arbitrating unit and the control units respectively. The apparatus further includes the circuits for compressing and expanding the image data in a reversible manner and a nonreversible manner so that the compressing and expanding manner may be switched according to the image processing condition. When treating a large amount of image data, this configuration makes it possible to reduce the number of accesses to memory and make effective use of a bandwidth, thereby being able to reduce the power consumption. Since the bandwidth is reduced and the random access to memory is made possible, more image processing capabilities may be provided so that the operability of this apparatus is enhanced.

### INCORPORATION BY REFERENCE

The present application claims priority from Japanese application JP2008-138855 filed on May 28, 2008, the content of which is hereby incorporated by reference into this application.

### BACKGROUND OF THE INVENTION

The present invention relates to an image processing apparatus. More particularly, the invention relates to an image processing system which is required to perform an operation of accessing a moving image or a still image in a memory, representatively, a dynamic random access memory (DRAM).

One of the background arts in the technical field to which the present invention belongs is disclosed in the Official Gazette of JP-A-10-301841. The Abstract of this Official Gazette describes “[Solving Problem] Though it is required to enhance a databand width in accessing a memory, a technique for speeding up an outside interface and a memory bus of a memory LSI confronts difficulty on design of electric circuitry. To overcome this difficulty, it is an object of the present invention to provide a memory LSI technique which realizes effective enhancement of a databand width by another way rather than the speed-up technique. [Solving Means] The memory LSI provided with a compressing and expanding function is configured to have a compressing and expanding portion 13 mounted therein. In this configuration, the portion 13 includes a data compressor 14 and a data expander 15. The data compressor 14 performs an operation of reading data from a memory 12 compressively and the data expander 15 performs an operation of writing data in the memory 12 compressively. [Effect] This technique makes it possible to realize an effectively larger databand width even though the physical databand width is held at the conventional width.”

Further, the Official Gazette of JP-A-2007-214813 discloses another background art. The Abstract of this Official Gazette describes “[Solving Problem] To efficiently compression-code image data if the number of quantized bits of pixel data of the image data is more than 8 bits but less than 16 bits [Solving Means] The pixel data is separated into 8 bits on the LSB (Least Significant Bits) side and the bits on the MSB (Most Significant Bit) side excepting the former 8 bits. The bits on the LSB side are compressed by using the DPCM (Differential Pulse Code Modulation) and the Huffman coding. The bits on the MSB side are processed by the run-length coding at each MSB-side bit with one byte of the MSB-side bits of an adjacent pixel as a unit. After processed, the MSB-side bits are processed by the run-length coding at each byte. The run-length coding at an MSB-side bit unit is executed only if all MSB-side bits of one byte are matched to each other. The number of runs is not outputted because it is stationary according to the number of quantized bits of the pixel data. These series of operations make it possible to properly code the LSB-side bits and the MSB-side bits and efficiently compress those bits as well as concurrently code the LSB-side bits and the MSB-side bits, thereby being able to speed up the coding process.”

Further, the Official Gazette of JP-A-2007-214814 discloses another background art as well. The Abstract of the Official Gazette describes “[Solving Problem] To decode compression-coded image data if the number of quantized bits of the pixel data of the image data is more than 8 bits but less than 16 bits [Solving Means] The pixel data with more than 8 quantized bits but less than 16 quantized bits is separated into a first portion consisting of 8 bits on the LSB side and a second portion consisting of the bits on the MSB side excepting the first portion. This decoding technique treats the first compression coded data generated by executing the reversible first compression coding with respect to the first portion and the second compression coded data generated by executing the reversible second compression coding with respect to the second portion, the second compressing coding being different from the first compressing coding. The decoding technique is executed to decode the first and the second compression coded data respectively, integrate the first decoded data generated by decoding the first compression coded data with the second decoded data generated by decoding the second compression coded data so that the pixel data of the second decoded data corresponds with the the pixel data of the first decoded data, and output the integrated data.”

Today, the digital image processing is likely to be required to process more and more pixels as more the broadcasting programs are kept high-definitive and the recent digital camera is required to have more pixels.

In order to process these image signals, it is necessary to execute the processes of removing noise components on an image, compressing an image signal so that the image signal may be recorded on a recording medium such as a harddisk drive (referred to as a HDD) or an optical disk (referred to as a DVD) at a constant bit rate, rendering an image so that an operation guidance or program information may be displayed on a screen, and so forth. These processes all require the image data to be temporarily written in a memory such as a synchronous DRAM (referred to as a SDRAM).

As the image is kept high-definitive, the access to memory becomes very frequent. This frequent access may lead to making the power consumption larger and the final products more costly.

The Official Gazette of JP-A-10-301841 discloses the invention which concerns with a memory integrated circuit as well as a main storage system and a graphic memory system configured to use the memory integrated circuit, in particular, a large-volume semiconductor memory LSI (Large Scale Integrated Circuit) used to compose a main storage system or a graphic memory system in a computer system, and realizes an effectively larger databand width of this kind of memory even if the physical databand width is the same as that of the prior art.

Further, the just aforementioned Official Gazette also discloses the invention which is capable of processing the image data having a bit width of 8 bits or more. This invention is configured to separate the bit width into 8 bits on the MSB side and 8 bits on the LSB side and to compress or expand these bits respectively.

In the aforementioned Official Gazettes of JP-A-10-301841, JP-A-2007-214813 and JP-A-2007-214814, the disclosed inventions provide a capability of reducing the number of accesses to memory and increasing the bandwidth to be effectively used in the process of compressing image data, writing the compressed data in a memory, reading the data from the memory and expanding the data.

In the LSI to be used for processing the image data, however, a single access is not always given to a memory. Two or more accesses are often given to a memory. Hence, if the just aforementioned process is executed with respect to one systematic access to memory, the effect of reducing the number of accesses to memory is quite small, so that the reducing effect is restricted.

Moreover, the image processing configured to have the access to memory is required to cope with the processes of linearly accessing to an address of the memory in FIFO (First-in First-out) manner and accessing thereto randomly.

### SUMMARY OF THE INVENTION

In order to solve the foregoing problem, therefore, it is an object of the present invention to provide an image processing apparatus which is configured to locate a compressing and expanding unit for compressing and expanding image data between each control unit for image processing and an arbitrating unit for arbitrating two or more control units, have a reversible compressing and expanding system circuit and a nonreversible compressing and expanding system circuit as the compressing and expanding unit, and properly switch the reversible compressing and expanding system to the nonreversible system or vice versa.

In particular, the foregoing problem will be solved by the inventions described in the claims.

According to an aspect of the invention, the image processing apparatus is capable of reducing the number of accesses to memory even when processing image data composed of a massive amount of information and making an effective use of a bandwidth, thereby being able to reduce the power consumption.

Further, the image processing apparatus is capable of reducing a bandwidth and accessing a memory randomly, so that the apparatus may include more image processing functions. Hence, the resulting image processing apparatus enhances its usability.

The other problems, configurations and effects rather than the aforementioned ones will be described along the following embodiments.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an image processing apparatus according to a first embodiment of the present invention;

FIG. 2 is a block diagram showing an exemplary compressing unit included in the first embodiment;

FIG. 3 is a block diagram showing an exemplary expanding unit included in the first embodiment;

FIG. 4 is a block diagram showing an exemplary compressing unit included in the first embodiment;

FIG. 5 is a block diagram showing an exemplary expanding unit included in the first embodiment;

FIG. 6 is a flowchart showing a compressing process included in the first embodiment;

FIG. 7 is a flowchart showing an expanding process included in the first embodiment;

FIG. 8 is a conceptual view showing the compressing and the expanding processes included in the first embodiment;

FIG. 9 is a block diagram showing image data to be inputted to the image processing apparatus of the first embodiment;

FIG. 10 is a block diagram showing an image processing apparatus according to the first embodiment of the present invention;

FIG. 11 is a block diagram showing an image processing apparatus according to a second embodiment of the present invention;

FIG. 12 is a block diagram showing an image processing apparatus according to a third embodiment of the present invention;

FIG. 13 is a block diagram showing an image processing apparatus according to a fourth embodiment of the present invention; and

FIG. 14 is a block diagram showing an image processing apparatus according to a fifth embodiment of the present invention.

### DESCRIPTION OF THE INVENTION

Hereafter, the embodiments will be described with reference to the appended drawings.

### First Embodiment

The description will be oriented to the configuration and the operation of the image processing apparatus according to a preferred embodiment of the present invention.

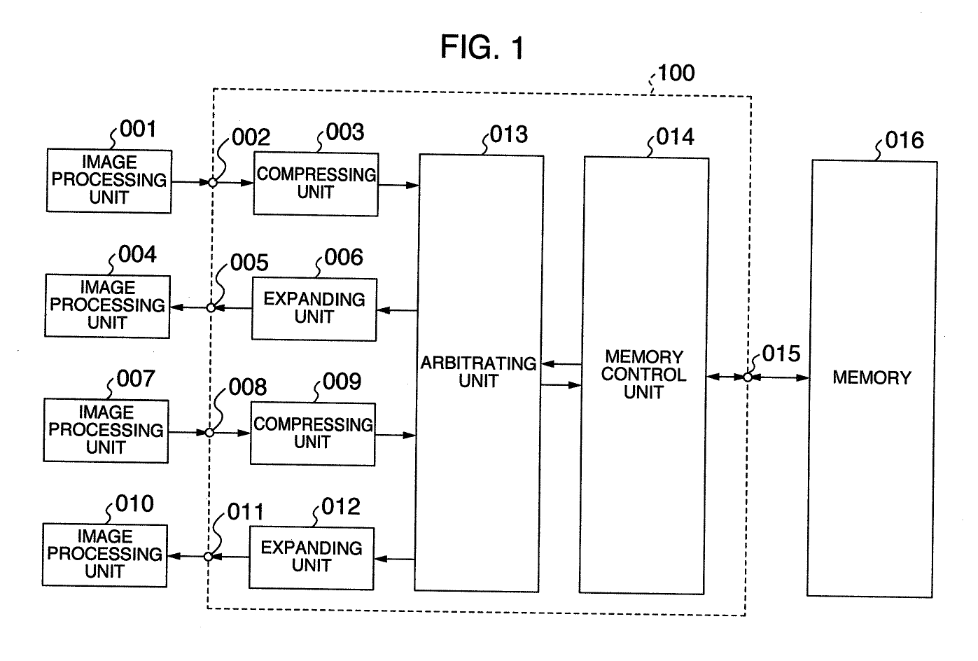

The configuration of this embodiment will be described with reference to FIG. 1.

In FIG. 1, the image processing units 001, 004, 007, 010 have a function of processing baseband signals such as a luminance signal and a color difference signal, each of those signals quantized at 8 bits as image data, at a frame unit. For this processing, those processing units need to write or read the data to or from a SDRAM. The baseband signals are inputted into compressing units 003 and 009 through input units 002 and 008 respectively.

Further, the baseband signals expanded by expanding units 006 and 012 are supplied to the image processing units 004 and 010 through output units 005 and 011 respectively. The compressing units 003, 009 or the expanding units 006, 009 are configured to write or read the image data in or from an outside memory 016 connected with a connection unit 015 through a memory control unit 014 in the selected sequence. The compressing unit 003 and the expanding unit 006 execute the compression and the expansion in a paired manner. The image data compressed by the compressing unit 003 may be expanded by the expanding unit 006.

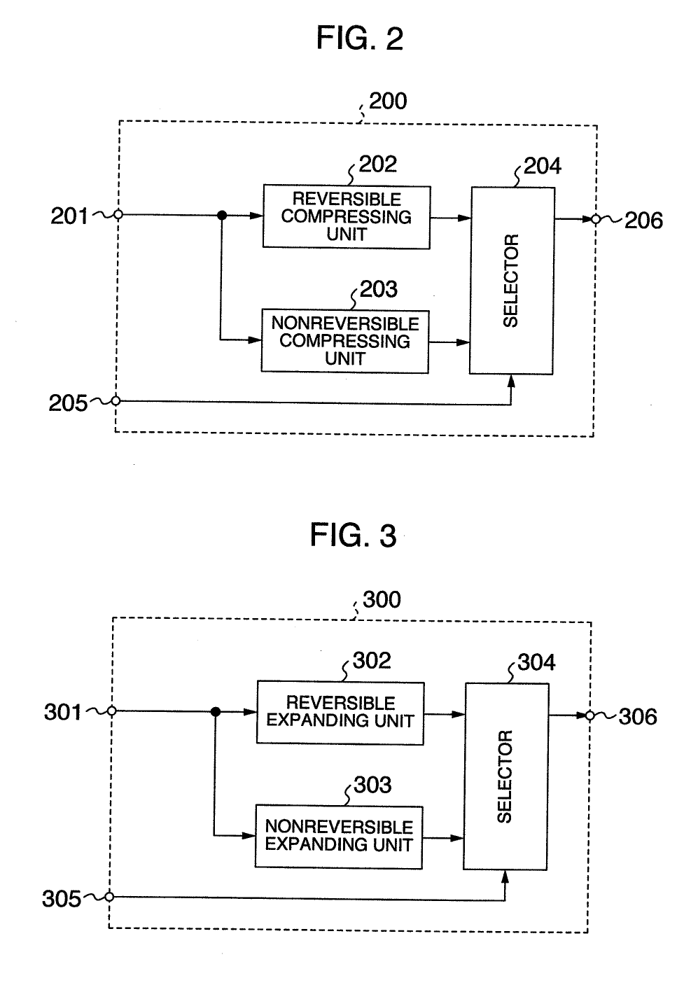

FIG. 2 shows the concrete configuration of the compressing unit 003 or 009. This configuration is served to switch a reversible algorithm or a nonreversible algorithm. The former algorithm is executed to keep the compressed or expanded image data alike to the pre-processed image data and the latter algorithm is executed to keep the compressed or expanded image data a little more degraded than the pre-processed image data.

The image data is inputted to the image processing apparatus through the input unit 201. In response to the signal supplied through the input unit 205, a selector 204 selects one of the reversible compressing unit 202 and the nonreversible compressing unit 203 and then outputs the image data compressed by the selected compressing unit to an output unit 206.

FIG. 3 shows the concrete configuration of the expanding unit 006 or 012. Like the compressing unit, the expanding unit is configured to switch the reversible algorithm into the nonreversible one or vice versa.

The compressed image data is inputted into the expanding unit 006 or 012 through an input unit 301. In response to a signal supplied from an input unit 305, a selector 304 selects one of a reversible expanding section 302 or a nonreversible expanding section 303. The selector 304 sends the image data expanded by the selected section 302 or 303 to an output unit 306 from which the signal is outputted.

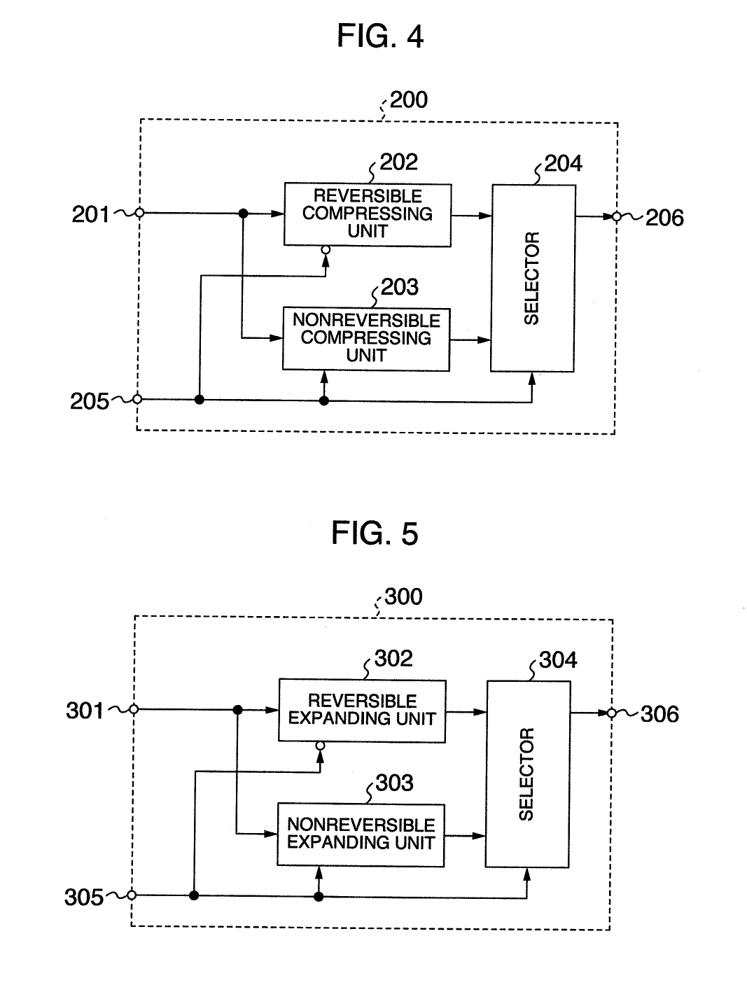

In the configuration shown in FIG. 4, to reduce the power consumption, the operation of the nonreversible compressing section 203, which is not selected when the other reversible compressing section 202 is selected in response to the selection signal of the compressing unit 003 or 009, is completely stopped. Likewise, in the configuration shown in FIG. 5, to reduce the power consumption, the operation of the nonreversible expanding section 303, which is not selected when the other reversible expanding section 302 is selected, is completely stopped.

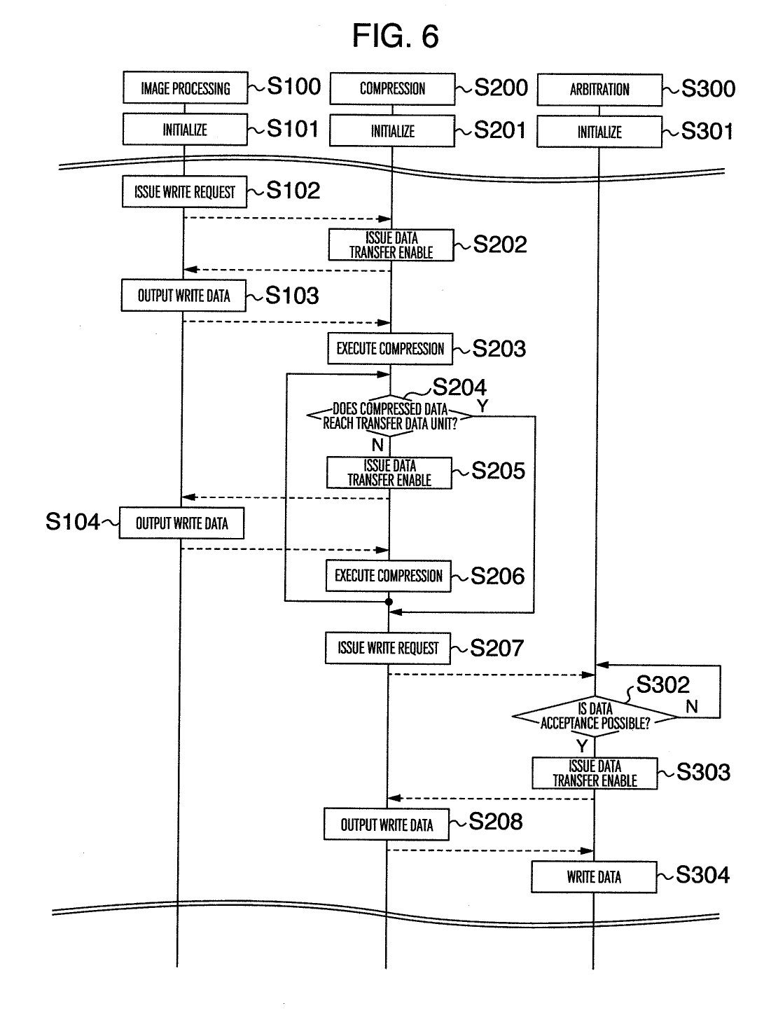

FIG. 6 shows the operation flowing from the compression of the image data by the compressing unit to the write of the compressed image data in the SDRAM.

In FIG. 6, the description will be oriented to the flow from the input of the image data by the image processing unit 001 to the expansion of the compressed image data by the expanding unit 006. This flow holds true to the image processing unit 007, the compressing unit 009 and the expanding unit 012.

At first, the image processing unit 001, the compressing unit 003 and the arbitrating unit 013 are initialized (S101, S201, S301). Herein, the control unit like the CPU sets register values on which a reset process and an operation mode are set.

At first, the image processing unit 001 issues a write request to the compressing unit 003 (S102). In response to the write request issued by the image processing unit 001, the compressing unit 003 issues a data transfer enable to the image processing unit 001 (S202). In response to the data transfer enable, the image processing unit 001 outputs the image data by 64 bytes, for example (S103). The compressing unit 003 compresses the image data sent from the image compressing unit 001 in a reversible or a nonreversible compressing manner according to the operation mode set at the initializing time (S203). The compressing unit 003 is configured to transfer the compressed image data to the arbitrating unit 013 64 bytes by 64 bytes. It is determined if the addition of the compressed image data and the coming compressed image data are to be packed into 64 bytes (S204). If possible, the compressing unit 003 issues the data transfer enable to the image processing unit 001 again (S205). Since the image processing unit 001 outputs the image data again, the image processing unit 001 virtually accesses the SDRAM twice (S104).

If not possible, that is, the data to be written to the SDRAM is fully filled, the compressing unit 003 issues the write request to the arbitrating unit 013 (S207). In response to the transfer request for write issued from the compressing unit 003, the arbitrating unit 013 determines if the data is to be accepted (S302). If not possible, the arbitrating unit 013 keeps the data transfer of the compressing unit 003 in readiness or the transfer request in queuing until the write of the data to the SDRAM becomes enabled. If possible, the arbitrating unit 013 issues the data transfer enable to the arbitrating unit 003 (S303).

In response to the data transfer enable issued by the arbitrating unit 013, the compressing unit 003 outputs the compressed write data to the arbitrating unit 013. The arbitrating unit 013 completes the data write by just one access to the SDRAM under the control of the memory control unit 014.

In the foregoing configuration, the compression ratio of the compressing unit 003 is set to a half. However, if the compression ratio is set to another value, the number of writes to the SDRAM may be effectively reduced.

In turn, the description will be oriented to the process of reading the written compressed image data from the outside memory 016 and expanding the compressed data.

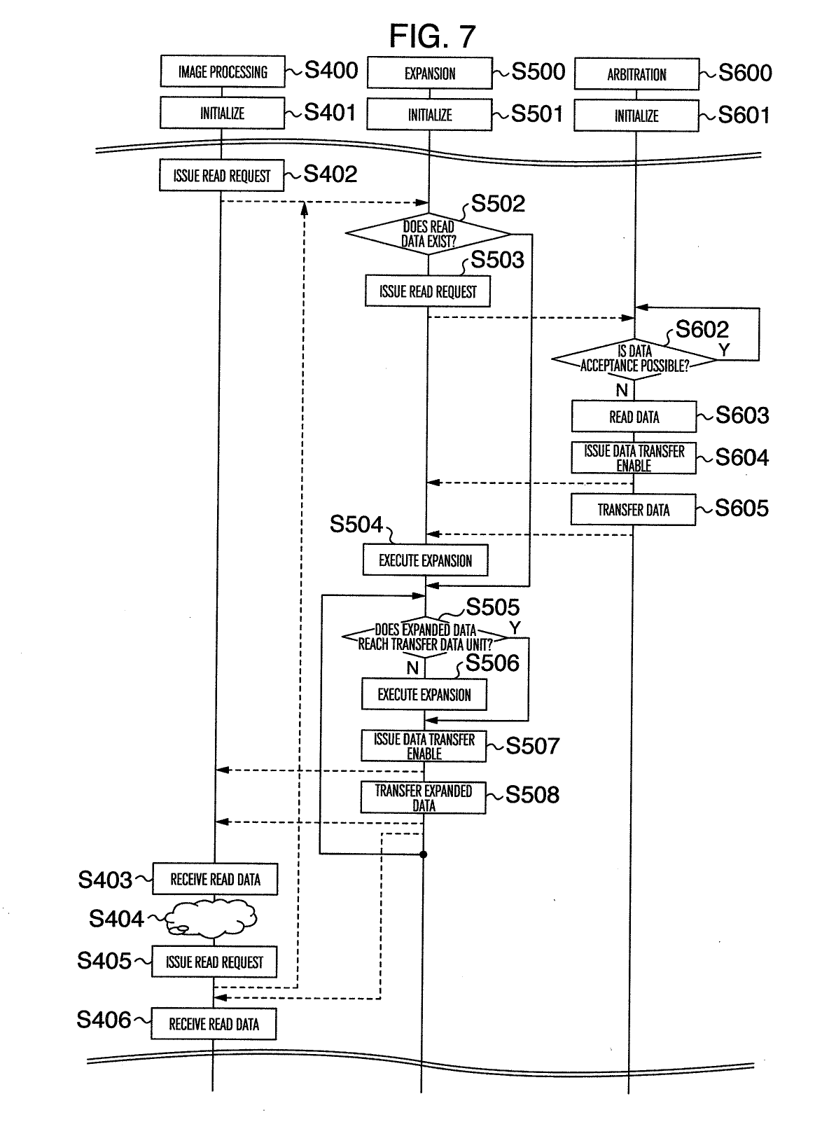

FIG. 7 shows an operation flowing from the read of the compressed image data written in the SDRAM from the outside memory 016 to the expansion of the read image data by the expanding unit to the supply of the expanded image data to the image processing unit.

Like the compression, at first, the image processing unit 004, the expanding unit and the arbitrating unit 013 are initialized (S401, S501, S601). In this operation, the control unit like the CPU sets register values on which the resetting process and the operation mode are set. However, if the arbitrating unit 013 is initialized in the compressing operation, the unit 013 is not necessarily initialized again.

At first, the image processing unit 004 issues a read request to the expanding unit 006 (S402). In response to the read request from the image processing unit 004, the expanding unit 006 determines if the image data being expanded exists in the expanding unit 006 (S502). If no concerned image data exists, the expanding unit 006 issues a read request to the arbitrating unit 014 (S503). If any concerned image data exists, the expanding unit 006 does not issue the transfer request for read. When the read request issued from the expanding unit 006 is detected, if the read of the image data out to the outside memory 016 is disabled, the arbitrating unit 014 keeps the expanding unit in readiness or the reading request in queuing until the read of the image data out to the outside memory 016 is enabled (S602). If the readout of the image data to the outside memory 016 is enabled, the arbitrating unit 014 executes the reading process (S603), issues the data transfer enable to the expanding unit 0056 (S604), and executes the data transfer through the memory control unit 014 (S605). The expanding unit 006 expands the compressed image data received from the arbitrating unit 013 (S504). The expanding unit 006 determines if the volume of the expanded image data reaches a data volume unit for one transfer to the image processing unit 004 (S505). If not, the expanding unit 006 executes the expanding process again (S506). If it reaches the data volume unit for one transfer, the expanding unit 006 issues the data transfer enable to the image processing unit 004 (S507).

In succession, the expanded image data is transferred to the image processing unit 004 (S508). The image processing unit 004 receives the image data (S403), performs the process specific to the image processing unit 004 (S404), and, if necessary, issues the read request to the expanding unit again (S405). In operation, the expanding unit 006 checks if the image data being expanded exists (S502) and, if it exists, enters into a transfer size determining process (S504). If it is determined that the volume of the expanded image data is greater than or equal to a data volume unit for one transfer, the expanding unit 006 issues the data transfer enable (S507) and executes the data transfer (S508).

The operation needs just one access to the outside memory 016 for reading the compressed image data, causes the expanding unit 006 to expand the compressed image data into the original image data, and causes the original image data to be transferred to the image processing unit 004 by just two accesses.

The foregoing operation holds true to the compression set to a half. If the compression ratio is set to another value rather than a half, the time of accesses to the outside memory 016 may be effectively reduced.

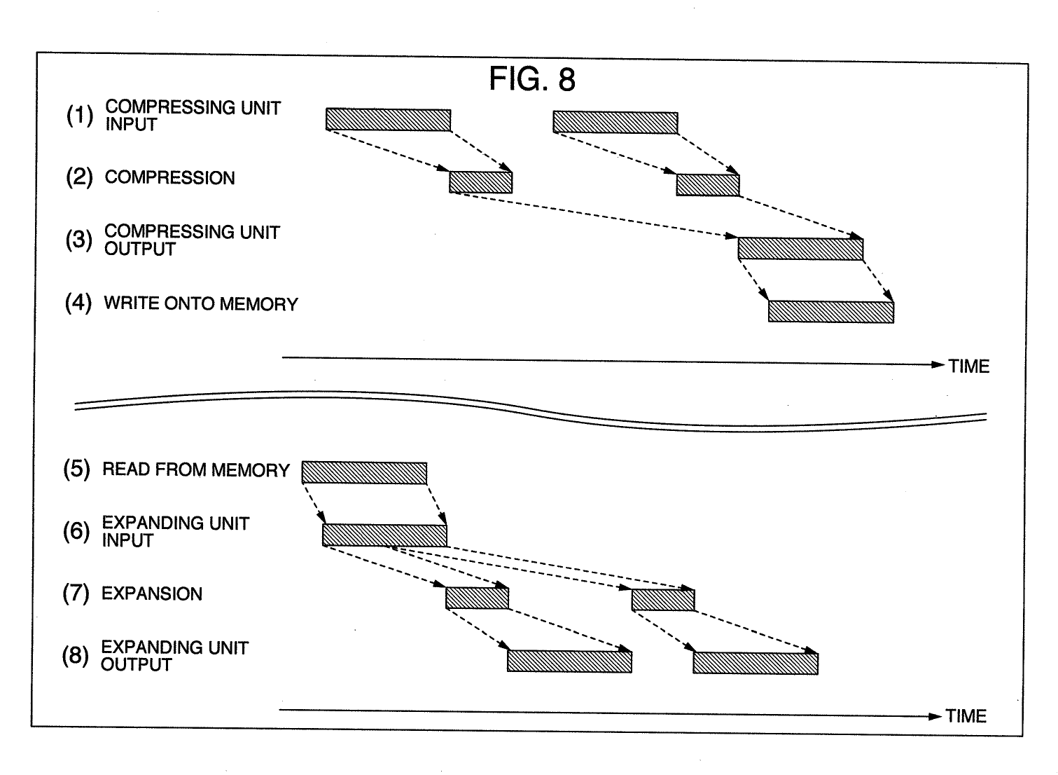

FIG. 8 is a conceptual view showing a processing operation of image data in the image processing unit 001.

When the data is inputted into the compressing unit 003, in response to one write request, the data is transferred by 64 bytes. In order to keep compatibility with various image processing components, it is preferable to set this transfer data unit as an accessible burst size of the SDRAM in response to one command. As to the compressing unit 003, for example, the compression ratio is set to a half and the data transfer unit is set to 32 bytes. The size of data to be written in the memory is made to be the burst size of 64 bytes. Hence, since no access to the memory occurs until the data size reaches the burst size, no data is written in the memory until the coming image data is inputted to the compressing unit and the volume of the compressed image data reaches 32 bytes.

When reading the data from the memory, at a time of reading the burst-sized data, the expanding process is executed. If the compression ratio is a half, the compressed image data of 64 bytes is divided into two parts, each part consisting of 32 bytes, and the expanding process is executed with respect to each part. Then, the expanded data is transferred to the image processing unit by 64 bytes. This operation makes it possible to reduce the number of accesses to the memory such as the SDRAM.

In particular, the image processing unit 001 or 004 is served to provide a process of removing noise components between the frames, a scaling process of enlarging or shrinking the number of vertical lines and the effective size of horizontal pixels of the inputted image data, a rendering process for an operation guidance or the like, and a process of converting a bit rate on which the image quality is defined so that the data may be recorded on a recording medium within a desired length of time. In actual, however, the processes to be executed by the image processing unit 001 or 004 are not limited to these processes.

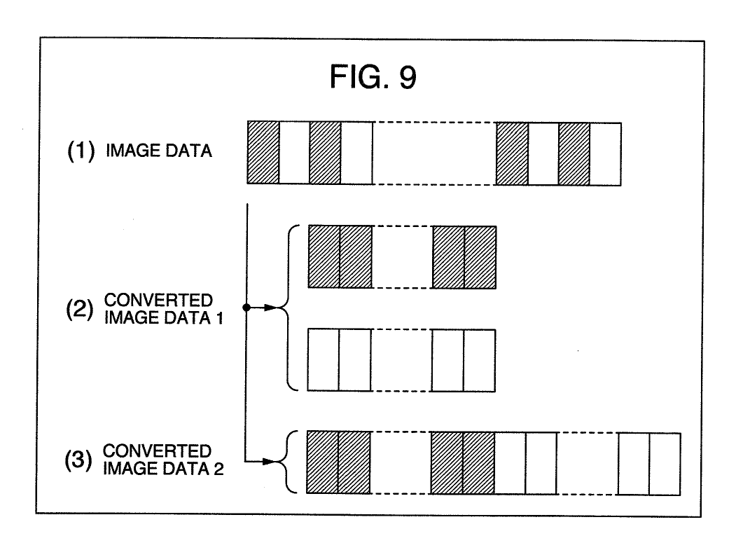

FIG. 9 shows an embodiment of the image data to be inputted into the compressing unit 003 or 009. If it is the baseband image data, it is considered that the image data is composed of luminance signal and the color-difference signal. That is, the luminance signal and the color-difference signal are mixedly contained in one burst. When the image data is compressed, as the data units to be compressed are made more correlative, the compressing efficiency is made higher. Hence, when the compressing unit compresses the image data with the luminance signal and the color-difference signal nested with each other in one burst, the compressing efficiency is likely to be inferior because the correlation between the luminance signal and the color-difference signal is taken in compressing the data.

To prevent this likelihood, by rearranging the signal into the luminance signal group and the color-difference signal group in one burst when compressing the image data, the data in one burst is made more correlative, so that the compressing efficiency is made higher. After the rearrangement, the luminance signal and the color-difference signal may be processed in parallel or in sequence. The same compressing effect can be obtained whichever process may be selected. Other than the luminance and the color-difference signals, by rearranging the RGB signals into each signal group, the same compressing effect can be obtained.

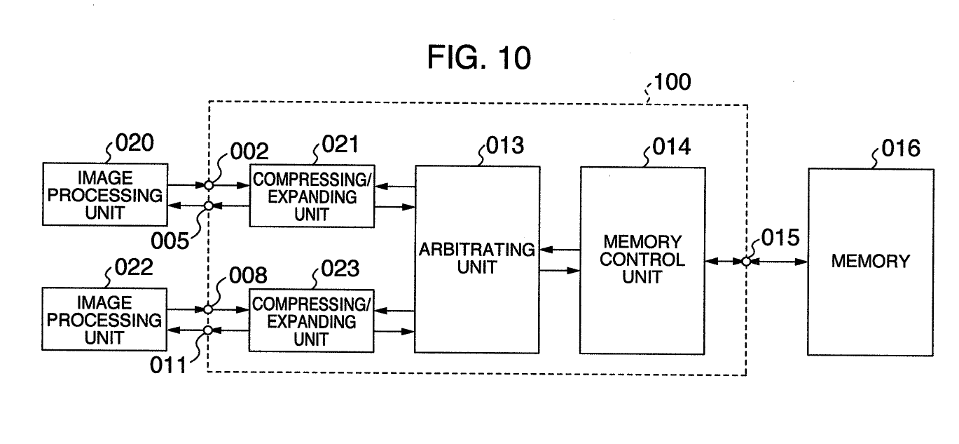

FIG. 10 shows the embodiment in which the compressing units and the expanding units are integrated into the compressing and expanding units 021 and 023, though the compressing units and the expanding units have been separately provided in the foregoing embodiment. This embodiment enables to offer the same effect as the configuration shown in FIG. 1.

Further, the image processing unit 020 or 022 may be configured to exclusively perform the compressing process and the expanding process. As another effect, this configuration makes it possible to reduce the circuitry of the compressing and expanding unit 021 or 023 in scale.

The concrete compressing and expanding system to be used in the compressing and expanding unit may be composed of an overall or a partial combination of predictive coding, frequency conversion, quantizing, run-length coding, entropy coding, arithmetic coding and universal coding. However, no special system is limited to the compressing and expanding system of the present invention.

### Second Embodiment

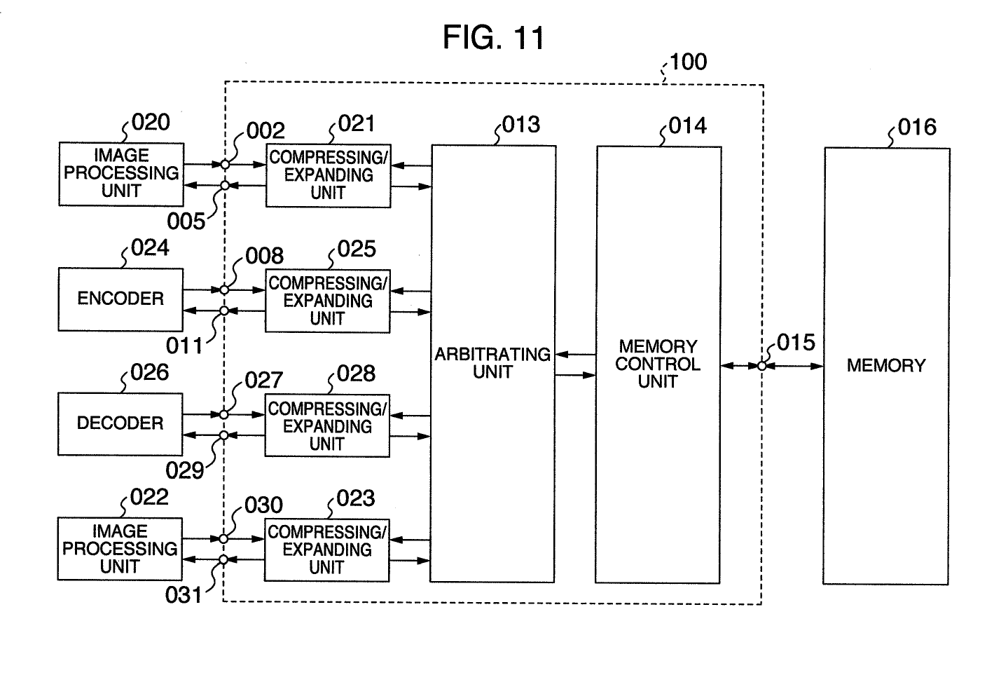

FIG. 11 shows another embodiment in which the concrete configuration of the image processing unit is embodied. If the shown components includes the components being functionally equal to those described with respect to the foregoing embodiments, these components are denoted by the same reference numbers as those of the foregoing embodiments, and thus the description thereabout is left out.

A first image processing unit 020 is served as a noise removing circuit, for example. This unit 020 operates to write the inputted image data in the memory 016 and remove the noise components based on the correlation between the frames.

Then, an encoder 024 is located as a second image processing unit in the system. The encoder is served to write the image data from which noise components are removed in the memory 016, read the image data from the memory 016 in sequence, and encode the image data so as to generate the coded data.

A decoder 026 is located as a third image processing unit in the system and is served to decode the coded data into the original image data.

Then, the fourth image process is executed to, for example, shrink the decoded image data in a thumbnail manner and paste the image.

In the system configured to execute the foregoing processes, the compression of the image data by the compressing and expanding units 021 and 025 before encoding of the image data by the encoder 024 causes the image data to be degraded. The degraded image data leads to the degraded quality of image. This is not preferable. Hence, the reversible compression is applied as the compression system to the image data so that no degraded quality of image is brought about and the compression effect is obtained.

The shrinkage of the decoded image by the image processing unit 022 has little adverse effect on the quality of image though the quality is slightly degraded. Hence, by securing a bandwidth margin in a high-efficient compressing system, the rendering process is made faster. As a result, the nonreversible compression is applied as the compression system to the image data.

The image processing apparatus of this embodiment allows the reversible system and the nonreversible system to be switchably applied to the proper stage of the image compression. This switchable application makes it possible to reduce the number of accesses to memory and to speed up the process as keeping the image quality excellent.

### Third Embodiment

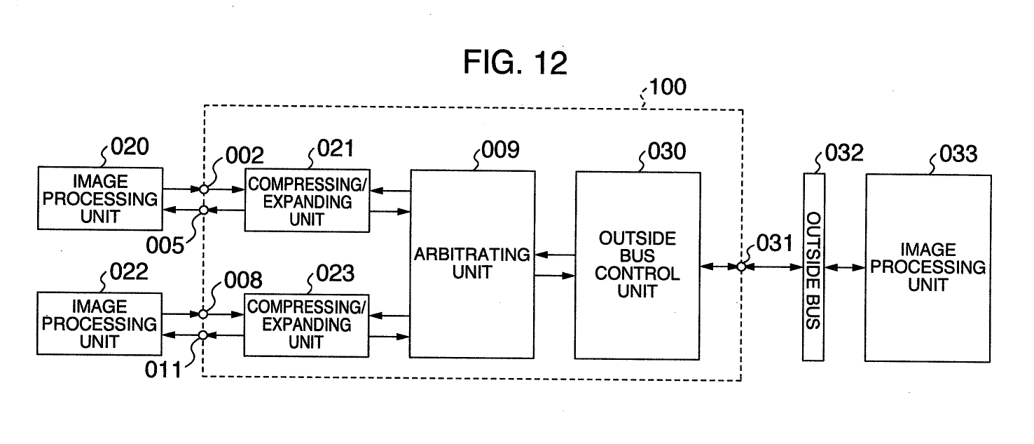

FIG. 12 shows the embodiment of the image processing apparatus which is applied to an external bus such as a PCI bus in place of the outside memory such as a DRAM. As mentioned above with respect to the second embodiment, the shown components being functionally equal to those of the foregoing embodiments are denoted by the same reference numbers and are not described below.

In place of the memory control unit connected between the arbitrating unit 013 and the memory 016, the outside bus control unit 030 is located so that the control unit 030 is connected with an outside bus 032 through the connection unit 031. This location is effective in reducing the number of accesses in not only the memory such as a DRAM but also the PCI bus.

Hence, the margin occurring in data communications with the outside image processing unit 033 connected with the outside bus 032 makes it possible to communicate a larger amount of information with the outside image processing unit 033.

### Fourth Embodiment

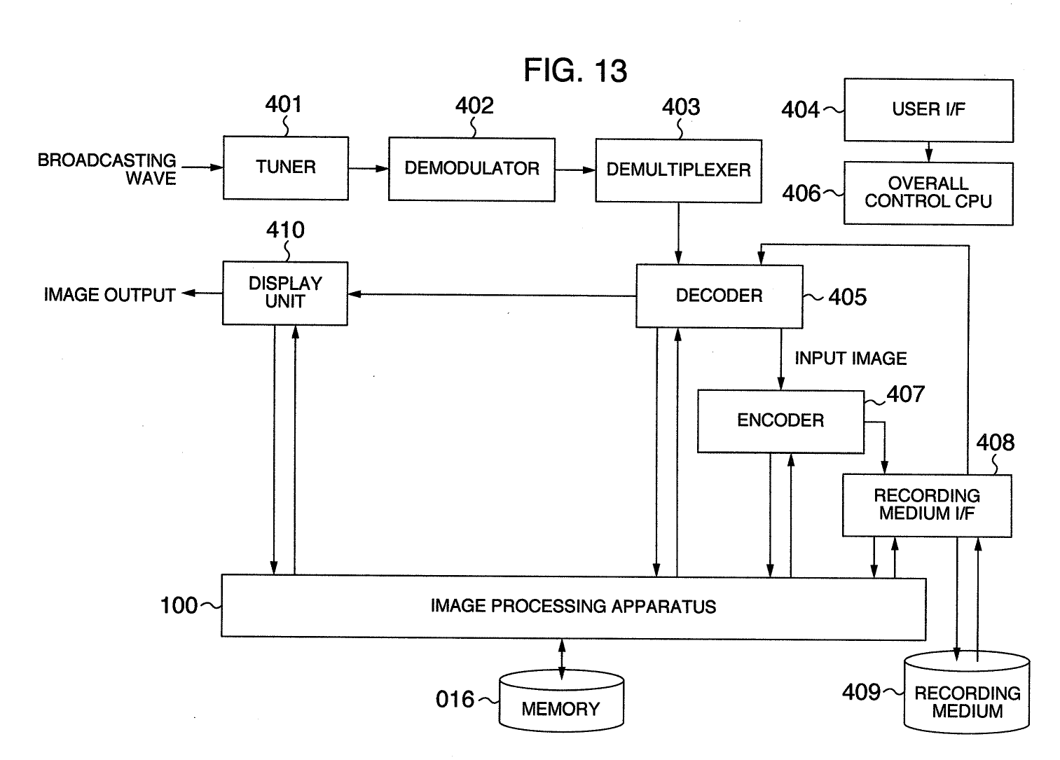

FIG. 13 shows a first practical product to which the foregoing embodiments are applied.

The first practical product according to the fourth embodiment is effective in receiving an analog or digital TV broadcasting signal and displaying the screen derived by decoding the signal, encoding and recording the received TV program on a recording medium such as a HDD or an optical disk, and reading the recorded program from the recoding medium, decoding the program and displaying the decoded program. As mentioned above, the components being functionally equal to those of the foregoing embodiments are denoted by the same reference numbers and are not described below.

A wave sent from a relaying station for a broadcasting satellite or the like is inputted into a tuner unit 401. The tuner unit 401 converts a RF-band wave into an IF-band signal and outputs as a signal in a fixed band not dependent on any receiving channel to a demodulating unit 402. The demodulating unit 402 demodulates the bit stream signal modulated for transmission, detects a code error occurring on the way of transmission, corrects the detected error, and outputs the corrected error to a demultiplexer unit 403.

The demultiplexer unit 403 decodes the signal encrypted for transmission, selects one transponder frequency on which a program is multiplexed, and separates the bit stream contained in the selected transponder into audio packets and video packets of one program.

The audio and the video packets are inputted to a decoding unit 405. The decoding unit 405 decodes the audio and the video packet stream and supplies the decoded image data to a display unit 410. To record the contents on a recording medium 409, an encoding unit 407 converts a compression ratio of the stream. The stream whose compression ratio is changed is recorded on a recording medium 409 through a recording medium interface 408. Instead, the packet stream may be recorded directly from the demultiplexer 403 onto the recording medium 409.

The components composing this embodiment are controlled by an overall control CPU 406 based on the operation instructions inputted through a user interface 404.

In the configuration of this embodiment, an image processing apparatus 100 is located on the writing or reading passage from each component to the memory 016 such as an SDRAM.

This location of the image processing apparatus 100 makes it possible to offer the compressing effect to all accesses to the memory 016 and, if no change of state takes place, reduce the number of accesses, thereby being able to reduce the power consumption.

Further, since the compression gives rise to a margin of access to memory, that is, makes it possible to execute more accesses to memory, the increased possible accesses may be allocated to another application.

### Fifth Embodiment

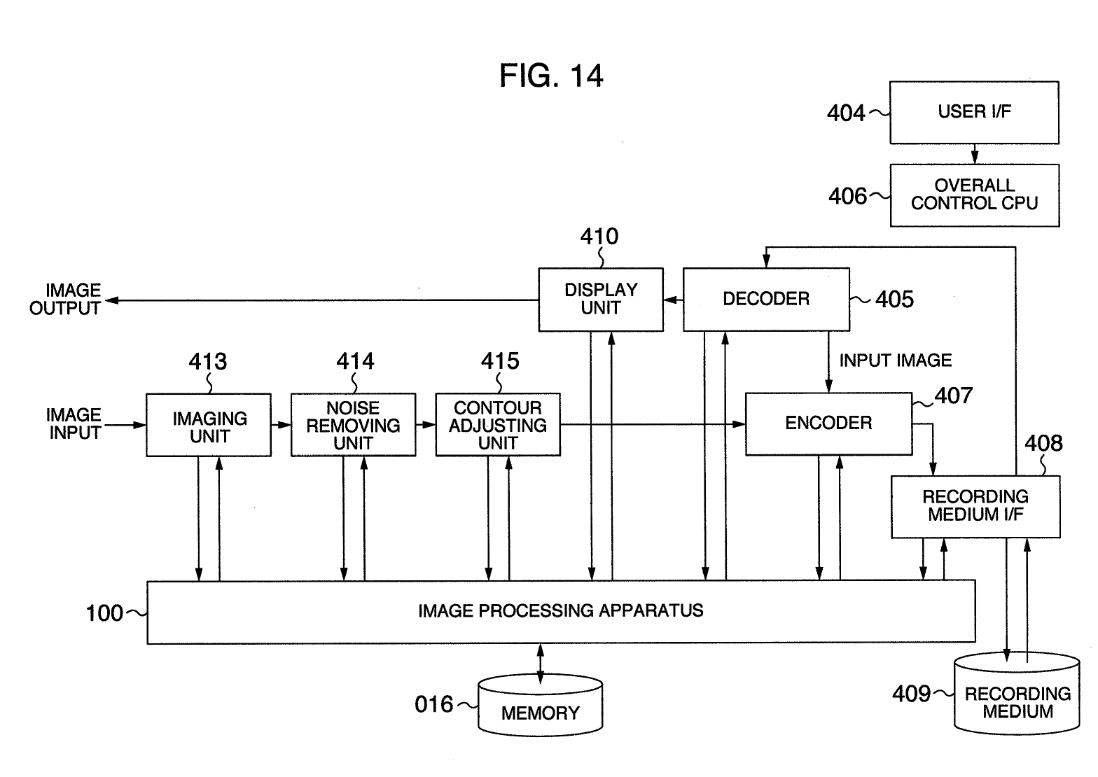

FIG. 14 shows a second practical product to which the foregoing embodiments are applied.

The second practical product of the fifth embodiment is effective in inputting image data from an imaging element such as a camera or digital image contents from the outside to the product, encoding the image data as changing an encoding rate, and recording the encoded image data on a recording medium such as a HDD or a magneto-optical disk. As mentioned above, the components being functionally equal to those of the foregoing embodiments are denoted by the same reference numbers.

An imaging unit 413 is provided with a sensor composed of a CMOS or a CCD. The image data imaged by the imaging unit 413 is converted into the image data on baseband. The converted image data is sent to a noise removing unit 414 in which the noise components are removed from the image data by using the correlation between the frames, for example. The noise-removed image data is sent to a contour adjusting unit 415. The contour adjusting unit 415 enlarges or shrinks an effective pixel area of the noise-removed image data and then supplies the processed result to the encoding unit 407.

Also in this configuration, the image processing apparatus 100 is located between each component and the memory 016. This location makes it possible to reduce the number of accesses to memory.

Further, the reversible compression system is applied to the imaging unit 413, the noise removing unit 414 and the contour adjusting unit 415 located at the previous stage to the encoding unit 407. This application allows the compression to effectively reduce the accesses to memory in number.

The present invention is not limited to the foregoing embodiments and may be modified in various forms. For example, the description of the foregoing embodiments have been described in detail so that the reader may more clearly understand the present invention. All the components described above are not necessarily included in the present invention. Further, a partial configuration of one embodiment may be replaced with a partial configuration of another embodiment. Moreover, a partial or a whole configuration of one embodiment may be added to a configuration of another embodiment.

The present invention may be also applied to a system for controlling an image on baseband, for example.

It should be further understood by those skilled in the art that although the foregoing description has been made on embodiments of the invention, the invention is not limited thereto and various changes and modifications may be made without departing from the spirit of the invention and the scope of the appended claims.

1. An image processing apparatus for writing or reading image data onto or from a memory, comprising:
first compressing and expanding means for compressing first image data in a reversible compressing manner, writing the compressed image data onto the memory, reading the compressed first image data from the memory, and expanding the compressed first image data in a reversible expanding manner; and
second compressing and expanding means for compressing second image data in a nonreversible compressing manner, writing the second image data onto the memory, reading the compressed second image data from the memory, and expanding the compressed second image data in a nonreversible expanding manner; and
wherein if degrade of the image data caused by the compressing and expanding means is disallowed, the first compressing and expanding means is used for image processing, while if degrade of the image data caused by the compressing and expanding means is allowed, the second compressing and expanding means is used for image processing.

2. An image processing apparatus for writing or reading image data onto or from a memory, comprising:
image processing units for performing at least first and second image processings, respectively;
an arbitrating unit for arbitrating write of the image data from the first and second image processing units onto a memory or read of the image data from the memory;
a memory control unit for controlling the memory in response to a signal sent from the arbitrating unit;
the memory being connected with the memory control unit; and
at least first and second compressing and expanding units; and
wherein the first compressing and expanding unit is located between the arbitrating unit and the first image processing unit and the second processing and expanding unit is located between the arbitrating unit and the second image processing unit.

3. The image processing apparatus as claimed in claim 2, wherein the first and the second compressing and expanding units are configured to execute a reversible compression and expansion and a nonreversible compressing and expansion and are allowed to be switched according to the processing method of the first or the second image processing unit.

4. The image processing apparatus as claimed in claim 3, wherein the first and the second compressing and expanding units provide a capability of stopping one of the reversible and the nonreversible compressing and expanding systems.

5. An image processing apparatus for writing or reading image data onto or from a memory, comprising:
an encoder for compressing the image data;
a first image processing unit for processing the image data at an earlier stage of the encoder;
a second image processing unit for processing the image data at a later stage of the encoder;
an arbitrating unit for arbitrating write of the image data from the encoder and the first and the second image processing units onto a memory or read of the image data from the memory;
a memory control unit for controlling a memory in response to a signal sent from the arbitrating unit;
the memory being connected with the memory control unit; and
first to third compressing and expanding units; and
wherein the first compressing and expanding unit is located between the first image processing unit and the arbitrating unit, the second compressing and expanding unit is located between the second image processing unit and the arbitrating unit, and the third compressing and expanding unit is located between the encoder and the arbitrating unit.

6. An image processing apparatus for writing or reading image data onto or from an outside bus, comprising:
image processing units for performing first and second image processings;
an outside bus;
an arbitrating unit for arbitrating write of the image data from the first and the second image processing units to the outside bus or read of the image data from the outside bus;
an outside bus control unit for controlling the outside bus in response to a signal sent from the arbitrating unit;
an outside bus being connected with the outside control unit; and
wherein the first compressing and expanding unit is located between the arbitrating unit and the first image processing unit and the second compressing and expanding unit is located between the arbitrating unit and the second image processing unit.

7. An image processing apparatus for writing or reading image data onto or from an outside bus, comprising;
an encoder for compressing the image data;
a first image processing unit for processing the image data at an earlier stage of the encoder;
a second image processing unit for processing the image data at a later stage of the encoder;
an arbitrating unit for arbitrating write of the image data from the encoder and the first and the second image processing units onto the outside bus or read of the image data from the outside bus;
an outside bus control unit for controlling the outside bus in response to a signal sent from the arbitrating unit;
the outside bus being connected with the outside bus control unit; and
first to third compressing and expanding units; and
wherein the first compressing and expanding unit is located between the first image processing unit and the arbitrating unit, the second compressing and expanding unit is located between the second image processing unit and the arbitrating unit, and the third compressing and expanding unit is located between the encoder and the arbitrating unit.

8. The image processing apparatus as claimed in claim 5, wherein the first compressing and expanding unit compresses or expands the image data in a reversible compressing and expanding manner and the second and the third compressing and expanding units compress or expand the image data in a nonreversible compressing and expanding manner.

9. The image processing apparatus as claimed in claim 1, wherein the information unit on which the first and the second compressing and expanding units process the image data at each processing time is adjusted to correspond to the minimum information unit on which the image data is written onto or read from the memory.

10. The image processing apparatus as claimed in claim 2, wherein the image data is rearranged in sequence, compressed or expanded within the amount of the information unit on which the first and the second compressing and expanding units process the image data at each processing time.

11. The image processing apparatus as claimed in claim 10, wherein before compressing or expanding the image data, the image data is rearranged into a series of luminance data and a series of color-difference data.

12. The image processing apparatus as claimed in claim 5, wherein the first and the third compressing and expanding unit are configured to switchably execute the process in a nonreversible compressing and expanding manner when accessing to the memory randomly or in a reversible compressing and expanding manner when accessing to the memory linearly.

13. The image processing apparatus as claimed in claim 6, wherein the first and the third compressing and expanding unit are configured to switchably execute the process in a nonreversible compressing and expanding manner when accessing to the outside bus randomly or in a reversible compressing and expanding manner when accessing to the outside bus linearly.

14. The image processing apparatus as claimed in claim 5, wherein when the first and the third compressing and expanding units are switched to the reversible compressing and expanding manner, the response time to the execution of the compression is regulated so that if no coming image data is inputted within a predetermined length of time after the initial compression is executed, the compressed image data is written onto the memory or the memory.

15. The image processing apparatus as claimed in claim 6, wherein the outside bus is a PCI bus.
